(19) United States
(12) Patent Application Publication
(10) Pub. No.: US 2004/0093914 A1
(43) Pub. Date: May 20, 2004

(54) Tamper resistant padlock

(76) Inventor: Robert A. Vito, Berwyn, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/342,596

(22) Filed: Jan. 15, 2003

Related U.S. Application Data
(63) Continuation-in-part of application No. 29/171,066, filed on Nov. 15, 2002.
(63) Continuation-in-part of application No. 29/171,774, filed on Nov. 27, 2002, now Pat. No. D476216.
(63) Continuation-in-part of application No. 29/171,738, filed on Nov. 27, 2002.

(51) Int. Cl. E05B 67/38

(52) U.S. Cl. 70/38 A; 70/56

(57) ABSTRACT

A tamper resistant padlock including a lock housing having a surface defining a bore having an inner surface. A shackle has first and second legs and is moveable between a first position, in which the first and second legs are located within the lock housing with the second leg being disposed in the bore, and a second position, in which the second leg is separated from the bore of the lock housing. A shield is disposed around the second leg. Wherein when the shackle is in the first position, a portion of the shield is proximate to the surface of the lock housing to essentially cover at least a portion of any gap between the inner surface of the bore and the second leg of the shackle.

### CROSS REFERENCE TO RELATED APPLICATIONS

This application is a continuation-in-part and claims priority from the following U.S. Design Patent Applications: U.S. Design patent application Ser. No. 29/171,066, filed Nov. 15, 2002, entitled ‘Shackle”; U.S. Design patent application Ser. No. 29/171,774, filed Nov. 27, 2002, entitled “Lock”; U.S. Design patent application Ser. No. 29/171,738, filed Nov. 27, 2002, entitled “Shackle;” each of the three above-identified patent applications is hereby incorporated by reference herein in its entirety as if fully set forth.

### BACKGROUND

The present invention is directed to padlocks and, more specifically, to tamper resistant padlocks that incorporate a shield to protect against disablement.

Padlocks can typically be disabled using a razor thin shank, or blade, that is inserted between a leg of the shackle and a lock bore that receives that leg. Such shanks are typically inserted along an inner surface of a shackle leg to allow a ball bearing or similar leg engaging device to be displaced and disengaged from a notch in the shackle leg to allow an unauthorized user to merely slide the shackle outwardly to disable the lock.

It would advantageous to provide a tamper resistant padlock that can not be disabled with thin shanks such as those stolen from law enforcement officials and used during criminal activities.

### SUMMARY

One embodiment of the present invention is directed to a tamper resistant padlock including a lock housing having a surface defining a bore having an inner surface. A shackle has first and second legs and is moveable between a first position, in which the first and second legs are located within the lock housing with the second leg being disposed in the bore, and a second position, in which the second leg is separated from the bore of the lock housing. A shield is disposed around the second leg. The shield is formed of a rigid material and is any one of welded to the second leg and integrally formed with the shackle. A locking mechanism is adapted to detachably secure a portion of the second leg within the lock housing when the shackle is in the first position. Wherein when the shackle is in the first position, a portion of the shield directly contacts the surface of the lock housing to cover any gap between the inner surface of the bore and the second leg of the shackle.

A separate embodiment of the present invention is directed to a tamper resistant padlock including a lock housing having a surface defining a bore having an inner surface. A shackle has first and second legs and is moveable between a first position, in which the first and second legs are located within the lock housing with the second leg being disposed in the bore, and a second position, in which the second leg is separated from the bore of the lock housing. A shield is disposed around the second leg. The shield is formed of a rigid material and is any one of welded to the second leg and integrally formed with the shackle. A locking mechanism is adapted to detachably secure a portion of the second leg within the lock housing when the shackle in the first position. Wherein when the shackle is in the first position, a portion of the shield is located proximate to the surface of the lock housing to define a rigid pathway that extends generally through an approximately ninety (90) degree bend. Whereby the approximately ninety (90) degree bend of the rigid pathway is adapted to prevent a lock pick from sliding into the bore between the second leg and the inner surface of the bore.

In a separate embodiment, the present invention is directed a tamper resistant padlock including a lock housing having a surface defining a bore having an inner surface. A shackle has first and second legs and is moveable between a first position, in which the first and second legs are located within the lock housing with the second being disposed in the bore, and a second position, in which the second leg is separate from the bore of the lock housing. A portion of the second leg, that is at least partially outside of the lock housing and is adjacent and/or positioned through the surface when the shackle is in the first position, has a generally oval cross-section. An end of the second leg has a generally circular cross-section of a smaller area than the generally oval cross-section such that the portion forms a shield for the end of the second leg. A locking mechanism is adapted to detachably secure a portion of the second leg within the lock housing when shackle is in the first position. Wherein when the shackle is in the first position, the shield extends across any gap between the inner surface of the bore and the second leg of the shackle to cover at least part of the any gap.

In a separate embodiment, the present invention is directed to a lock housing having a surface defining a bore having an inner surface. A shackle has first and second legs and is moveable between a first position, in the which the first and second legs are located within the lock housing with the second leg being disposed in the bore, and a second position, in which the second leg is separated from the bore of lock housing. A portion of the second leg, that is at least partially outside the lock housing and is adjacent and/or positioned through the surface when the shackle is in the first position, has a first cross-section. An end of the second leg has a second cross-section of a smaller area than the first cross-section such that the portion forms a shield for the end of the second leg. A locking mechanism is adapted to detachably secure a portion of the second leg within the lock housing when the shackle is in the first position. When the shackle is in the first position, the shield extends across any gap between the inner surface of the bore and the second leg of the shackle to cover at least part of the any gap.

### BRIEF DESCRIPTION OF THE DRAWINGS

The foregoing summary, as well the following detailed description of the preferred embodiments of the present invention, will be understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective view of a first preferred embodiment of the padlock of the present invention with a shackle in a first, closed position;

FIG. 2 is perspective view of the padlock of FIG. 1 with the shackle in a second, open position;

FIG. 3 is front elevational view of the padlock of FIG. 1;

FIG. 4 is a cross-sectional view of the padlock of FIG. 3 as taken along the line 4-4 of FIG. 3 and illustrates the generally annular shape of a shield that is positioned around a leg of the shackle;

FIG. 5 is a partial cross-sectional view similar to that of FIG. 4 of a second preferred embodiment of the padlock of the present invention illustrating a shield having an outer perimeter defining a generally square shape;

FIG. 6 is a partial cross-sectional view of the padlock of FIG. 4 as taken along the line 6-6 of FIG. 4 and illustrates the engagement of a locking mechanism with a leg of the shackle and illustrates at least one weld that is used to secure the shield to the leg of the shackle;

FIG. 7 is a view similar to that of FIG. 6 illustrating a padlock with the shield being integrally formed with the shackle;

FIG. 7a is enlarged view of the padlock of FIG. 7 illustrating the shackle in the first position with the a portion of the shield located proximate to the surface of the lock housing to define a rigid pathway that extends generally through and approximately ninety (90) degree bend, whereby the approximately ninety (90) degree of the rigid pathway is adapted to prevent a lock pick from being slid into the bore between the second leg and the inner surface of the bore;

FIG. 8 is a view similar to that of FIG. 7 of a third preferred embodiment of the padlock of the present invention illustrating the shield being integrally formed with the shackle and having an end, facing generally away from a surface of the lock housing, that is beveled;

FIG. 9 is a view similar to that of FIG. 7 of a fifth preferred embodiment of the padlock of the present invention with the surface of the lock housing having a groove therein which defines a shoulder against which a lower edge of the shield is seated;

FIG. 10 is a view similar to that of FIG. 9 illustrating a fifth preferred embodiment of the padlock of the present invention in which the surface includes a groove defining a shoulder to receive a shield having a different configuration from that illustrated in FIG. 9;

FIG. 11 is an enlarged view of the padlock of FIG. 9;

FIG. 12 is perspective view of a sixth preferred embodiment of the padlock of the present invention and illustrates a shield that is flush with the outer surface of the lock housing when the shackle is in the first position;

FIG. 13 is a perspective view of the padlock of FIG. 12 with the shackle in the second position;

FIG. 14 is a cross-sectional view of the padlock of FIG. 12 as taken along the line 14-14 of FIG. 12;

FIG. 15 is a view similar to that of FIG. 14 illustrating a seventh preferred embodiment of the padlock of the present invention with a shield that is partially recessed within a groove in the surface so that only a beveled portion of the shield extends above the surface of the lock housing;

FIG. 16 is a view similar to that of FIG. 14 of an eighth preferred embodiment of the padlock of the present invention illustrating the shield being flush with the surface of the lock housing when the leg is in the first position;

FIG. 17 is a perspective view of a ninth preferred embodiment of the padlock of the present invention illustrating the shackle having a shield on each leg;

FIG. 18 is a front elevational view of the padlock of FIG. 17;

FIG. 19 is a partial cross-sectional view of the padlock of FIG. 17 as taken along the line 19-19 of FIG. 17 illustrating the shields welded to the shackle;

FIG. 20 is a perspective view of tenth preferred embodiment of a padlock of the present invention illustrating the shackle having a generally oval cross-section throughout a transverse portion with leg ends that have a generally circular cross-section of a smaller area than the generally oval cross-section such that the lower portions of the oval cross-section forms a shield that extends across any gap between the inner surface of the bore and the second leg of the shackle to cover at least part of the any gap;

FIG. 21 is a perspective view of the padlock of FIG. 20 in the second position;

FIG. 22 is cross-sectional view of the padlock of FIG. 20 illustrating the placement of the bottom of the shield against shoulders that are formed in the surface of the lock housing;

FIG. 22A is an enlarged partial view of the padlock of FIG. 22 illustrating the shields located proximate to the surface of the lock housing to define rigid pathways that extend through at least one approximately ninety (90) degree bend to prevent a lock pick from being slid into the bores between a shackle leg and the inner surface of the respective bore;

FIG. 23 is a view similar to that of FIG. 20 of an eleventh preferred embodiment of the padlock of the present invention illustrating the shields formed by a transverse portion of the shackle directly contacting the surface of the lock housing to cover at least portion of the gap between the shackle legs and the respective bores;

FIG. 24 is a perspective view the shackle illustrated in FIG. 20;

FIG. 25 is a second perspective view of the shackle of FIG. 24;

FIG. 26 is a cross-sectional view of the shackle of FIG. 25 as taken along the line 26-26 of FIG. 25 illustrating the reduced area of the shackle legs relative to the shields formed by the transverse portion of the shackle;

FIG. 27 is a view similar to that of FIG. 26 illustrating that the shields formed by the enlarged cross-sectional area of the transverse portion of the shackle can have a generally circular shape or the like; and

FIG. 28 is a view similar to that of FIG. 27 illustrating that the leg ends of the shackle can be concentrically positioned relative to the shields formed by the transverse portion of the shackle.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the padlock and designated parts thereof. The words “a” and “one” are defined as including one or more of the referenced item unless specifically stated otherwise. This terminology includes the words above specifically mentioned, derivatives thereof, and words of similar import.

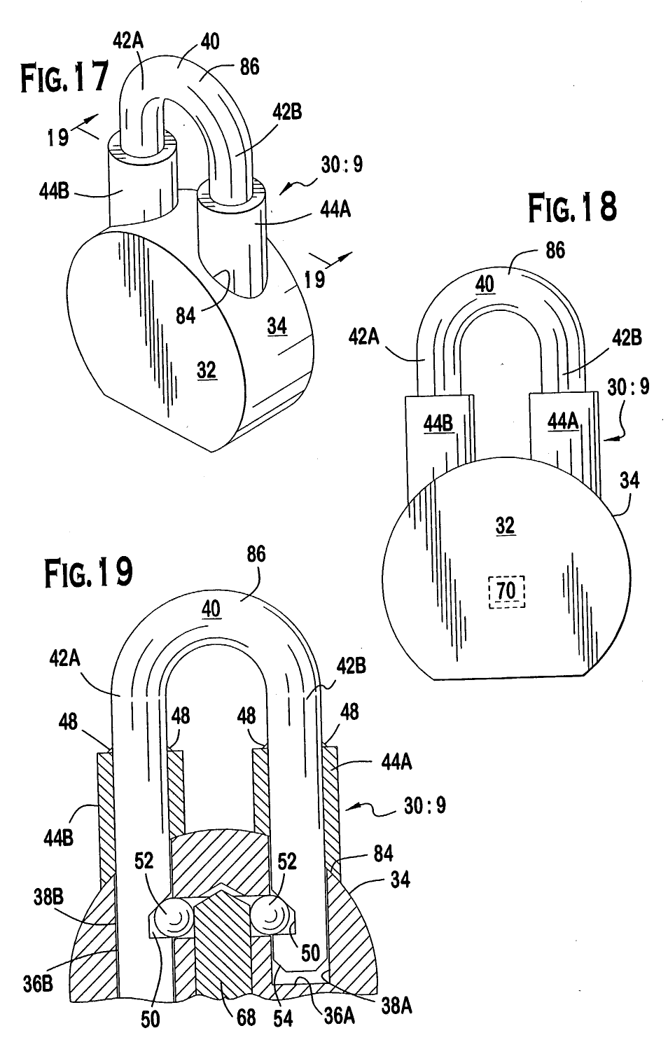

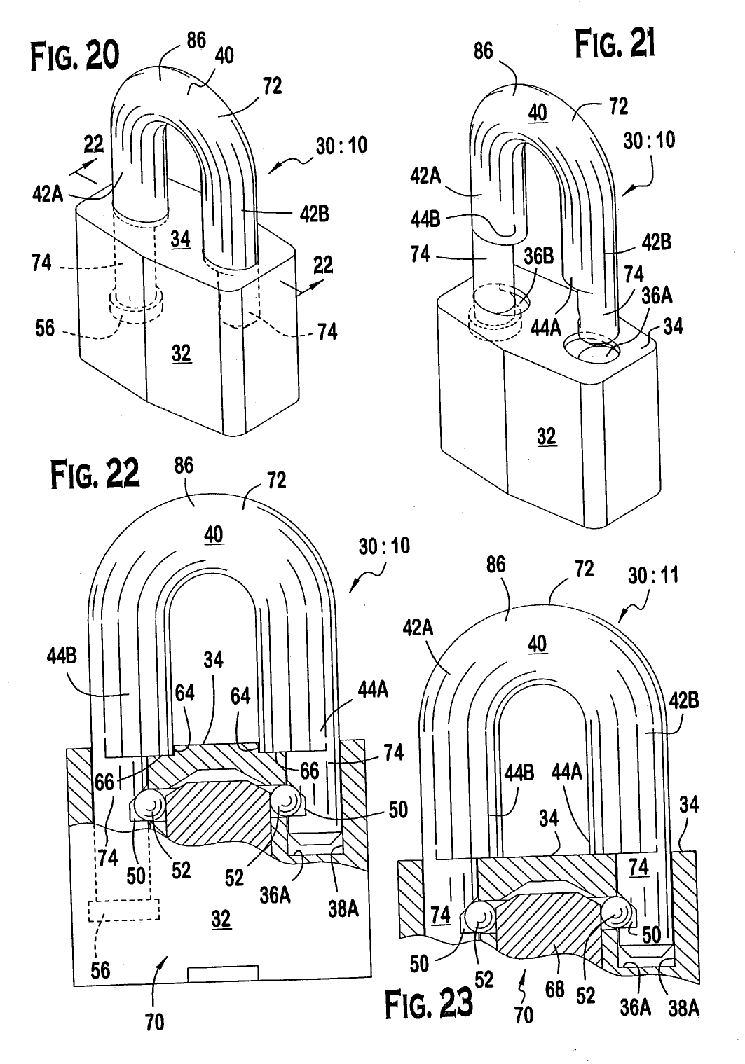

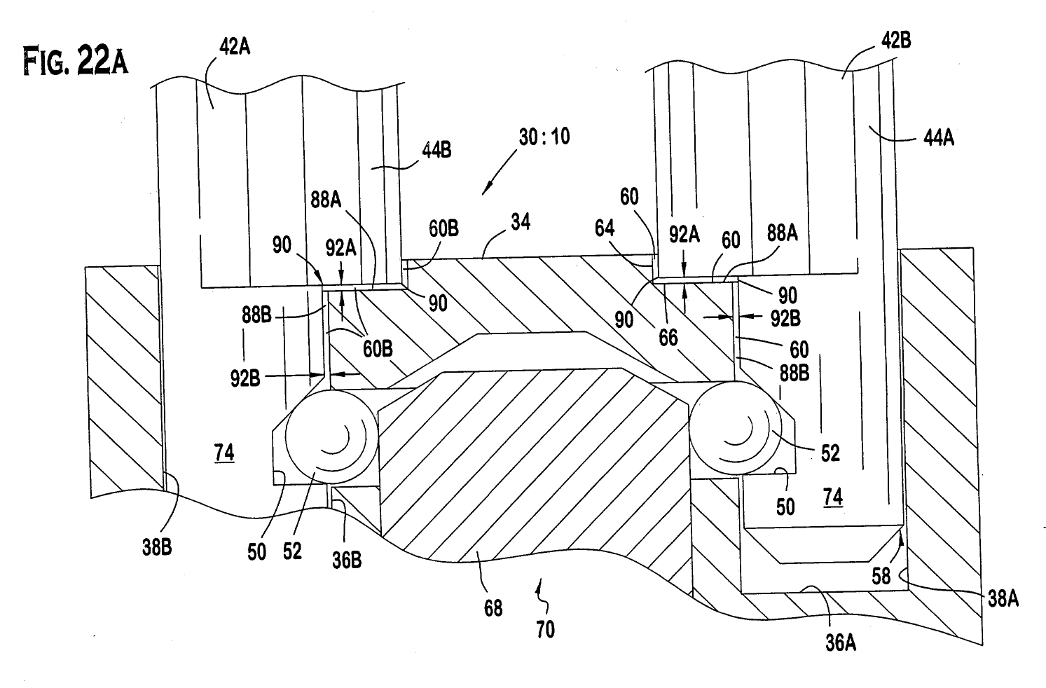

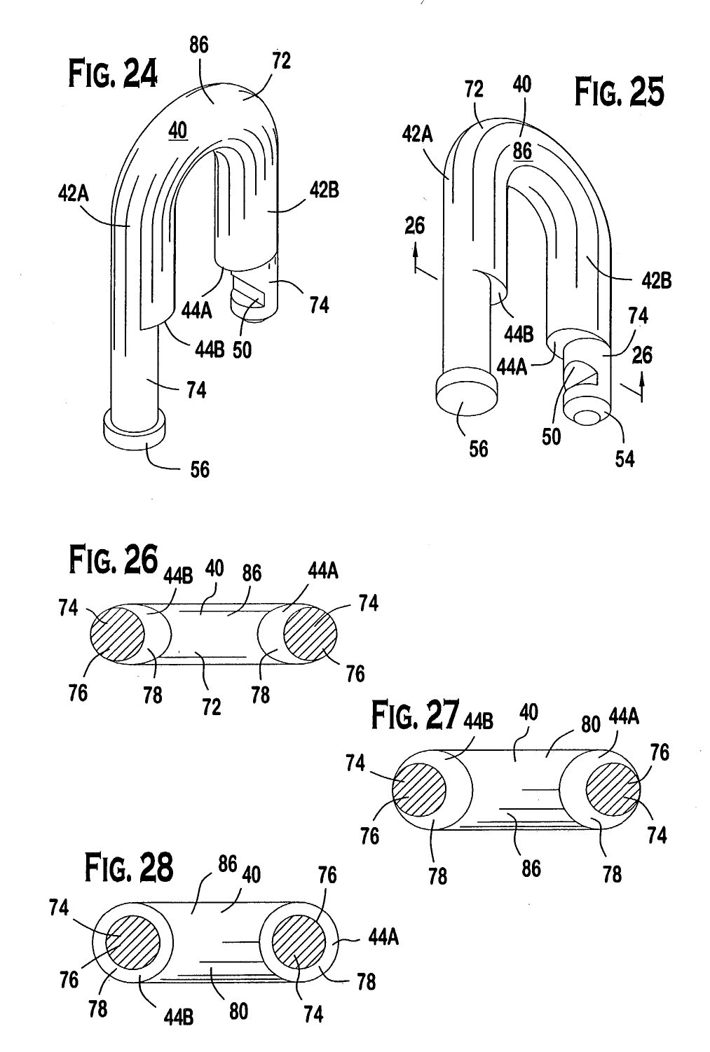

Referring to FIGS. 1-28, wherein like numerals indicate like elements throughout, eleven preferred embodiments of a padlock according to the present invention are shown and designated 30:1-30:11, respectively. Briefly stated, the padlock 30:1-30:11 incorporates a shield 44A to prevent a thin shank, blade or lock pick, from being inserted between a shackle leg and lock housing bore to disengage a locking mechanism 70 from the shackle leg. To be effective such a thin shank must be sufficiently rigid to displace a locking mechanism 70 (further described below) and razor thin. Such a shank would not be able to make the necessary bend to avoid the shield 44A without breaking or being otherwise blocked.

It is preferred that the padlock 30:1-30:11 and its individual components are formed of high strength, durable, impact resistant material, such as hardened steel. Those of ordinary skill in the art will appreciate from this disclosure that any other suitable metals, steels, alloys, or the like can used to form the padlock 30:1-30:11 without departing from the scope of the present invention.

Many features of the padlocks 30:1-30:11 of the present invention are similar and operate in generally similar fashion. Accordingly, it is understood that those features discussed in connection with any one of the embodiments of the padlock 30:1-30:11 will operate generally the same in the remaining embodiments unless otherwise described.

Referring to FIGS. 1-4, 6, and 7, one embodiment of the present invention is directed to a tamper resistant padlock 30:1 including a lock housing 32 having a surface 34 defining a bore 36A having an inner surface 38A. While the lock housing 32 is shown as having generally circular appearance, those of ordinary skill in the art will appreciate that the lock housing 32 can have any shape without departing from the scope of the present invention. The surface 34 of the lock housing 32 preferably defines a generally cylindrical bore 36A. However, those of ordinary skill in the art will appreciate that the cross-sectional shape of the bore 36A can vary without departing from the scope of the present invention. It is preferable that the lock housing 32 include a flat portion located proximate to a bottom end thereof to facilitate placing the padlock 30:1 in an upright position on a flat surface.

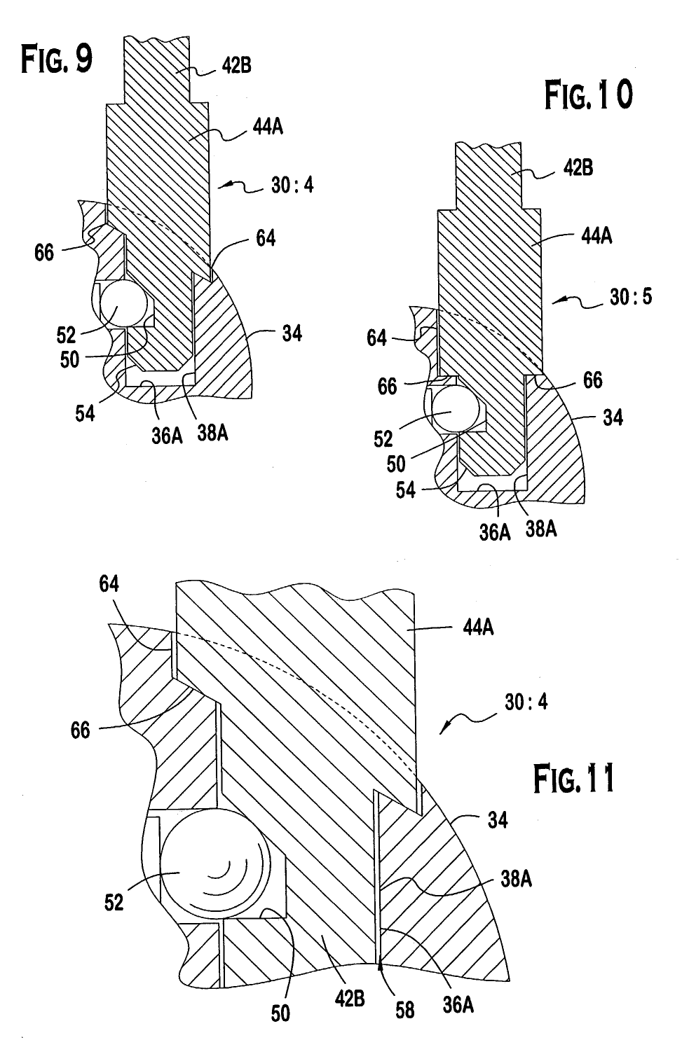

Referring to FIGS. 9-11, the surface 34 can define a groove 64 about at least a portion of the bore 36A to define a shoulder 66. It is preferred that the groove 64 receive at least a portion of the shield 44A therein so that a portion of the shield 44A is positioned adjacent the shoulder 66. Referring specifically to FIG. 11, the shoulder 66 can be inclined or irregularly shaped depending on the contour of the lower edge of the shield 44A. Referring to FIGS. 10 and 11, the shoulder can also be configured to receive a generally horizontal lower edge of the shield 44A.

Referring to FIGS. 12-14 and 16, the groove 64 can be configured to receive the shield 44A therein such that the shield 44A is flush with the surface 34.

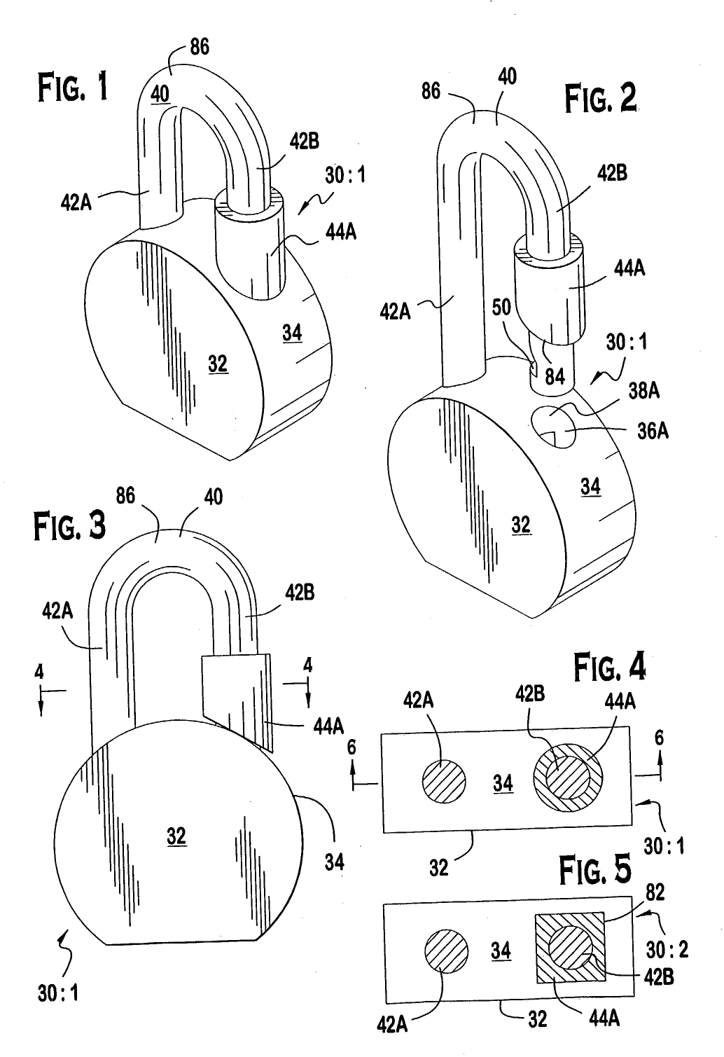

Referring again to FIGS. 1 and 2, the padlocks 30:1-30:11 of the present invention preferable include a U-shaped shackle. It is understood by those of skill in the art, that the shackle 40 can have any shape without departing from the scope of the present invention. The shackle 40 has first and second legs 42A, 42B and is moveable between a first position (shown in FIGS. 1 and 3), in which the first and second legs 42A, 42B are located within the lock housing 32 with the second leg 42 being disposed in the bore 36A, and a second position (shown in FIG. 2), in which the second leg 42B is separated from the bore 36A of the lock housing 32. Referring to FIGS. 24-26, the shackle may have a generally oval cross-section 72 throughout a transverse portion 86 that extends between the first and second legs 42A and 42B. Referring to FIG. 21, the first leg 42A of the shackle 40 is preferably slideably disposed in the second bore 36B. Referring to FIG. 6, it is preferred that stop 56 be positioned on the lower end of the first leg 42A to prevent the shackle 40 from being withdrawn from the lock housing 32. The stop 56 is preferably an outwardly directed flange or pin that prevents the shackle 40 from being completely withdrawn from the lock housing 32. However, the shackle 40 can be configured to be completely withdrawn from the lock housing 32 without departing from the scope of the present invention.

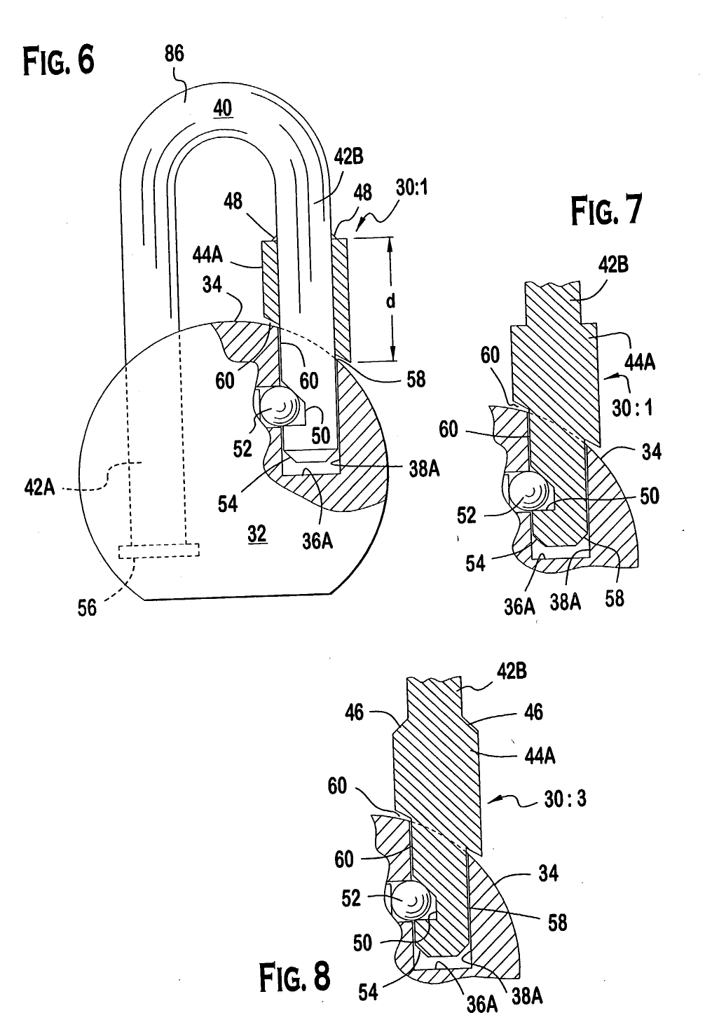

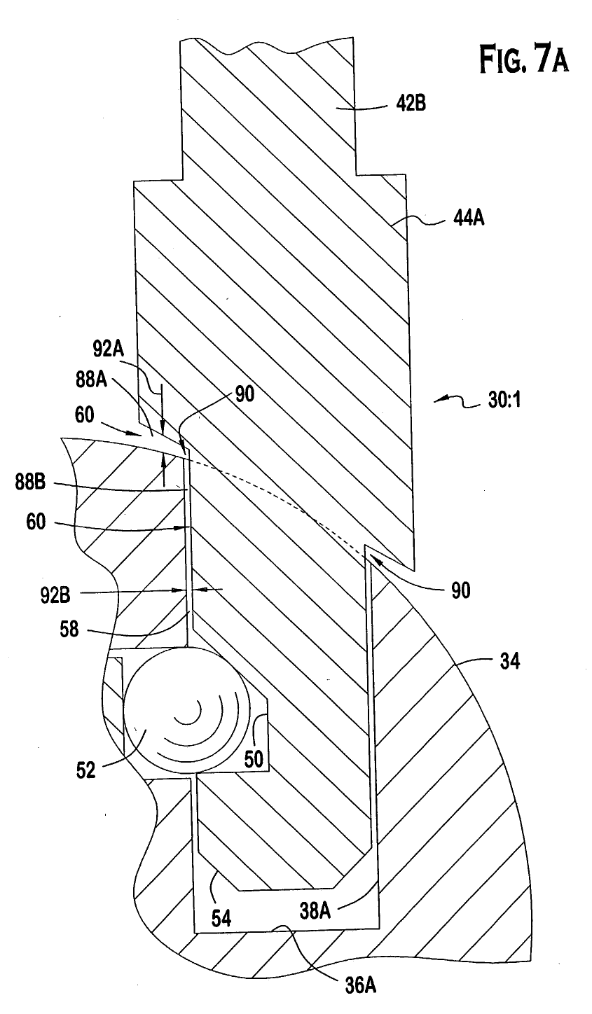

A shield 44A is preferably disposed around the second leg 42B. The shield 44A is preferably formed of a rigid material and is any one of welded to the second leg (as shown in FIG. 19) and integrally formed with the shackle (as shown in FIGS. 7 and 8). Referring to FIGS. 1 and 2, the shield 44A preferably has a generally annular shape and preferably comprises a generally tubular sleeve. Referring to FIG. 6, it is preferred that the length “d” of the tubular sleeve 44A is approximately one-half inch. Referring to FIG. 8, it is also preferred that the shield has an end, facing generally away from the surface 34, that is beveled. The beveled surface 46 makes it more difficult to brace a tool against the top edge of the shield 44A to facilitate prying or the like. Referring to FIGS. 17 and 18, it is preferred that when the surface 34 is curved, that an end of the shield 44A is curved to complement the surface 34 when the shackle 40 is in the first position (as shown in FIGS. 17 and 18). The curving of the lower end of the shield 44A, makes it more difficult to insert a pry member or shank between the shield 44A and the surface 34 of the lock housing 32. Referring to FIG. 5, those of ordinary skill in art will appreciate from this disclosure that the shape of the shield 44A (or the shape of second shield 44B; further described below) can vary and/or be irregular without departing from the scope of the present invention. As such, the shield can have an outer perimeter 82 defining a generally square shape, a triangular shape, a polygonal shape, an irregular shape or the like without departing from the scope of the present invention.

Referring to FIGS. 17-28, the padlock 30:1-30:11 of the present invention may incorporate a second shield 44B to protect portions of the gap between either of the shackle legs 42A, 42B and their respective bores. Referring to FIG. 19, positioning two shields 44A, 44B against the surface 34 of the lock housing 32 when the shackle 40 is in the first position protects against the use of razor thin shanks to disable either side of the double ball bearing 52 lock that is shown. In some cases, not covering the gap between the legs 42A, 42B and the inner surface 38A, 38B of the bores 36A, 36B will allow a shank to drive the ball bearing 52 generally inwardly resulting in the lock slide 68 being driven downwardly and disabling the padlock 30:1-3011.

Referring to FIGS. 20-28, the shields 44A, 44B can be formed by a reduction in the cross-sectional area of the lower ends of the legs 42A, 42B of the shackle 40. For example, a portion of the second leg 42B, that is at least partially outside the lock housing 32 and is adjacent and/or positioned through the surface 34 when the shackle 40 is in the first position, has a generally oval cross-section 72. A lower end of the second leg 42B preferably has a generally circular cross-section 76 of a smaller area than the generally oval cross-section 72 such that the portion having a generally over cross-section 72 forms a shield 44A, 44B for the lower end of the second leg 42B. It is preferable that the shields 44A, 44B formed by the lower ends of the generally oval cross-section 72 extends across any gap between the inner surface 38A, 38B of the bores 36A, 36B and the respective shackle legs 42B, 42A to cover at least a part of the any gap 58.

Referring to FIGS. 27 and 28, those of ordinary skill in the art will appreciate from this disclosure that the transverse portion 86 of the shackle 40 that forms the shields 44A, 44B can have any cross-section without departing from the scope of the present invention. That is, a portion of the second leg 42B, that is at least partially outside the lock housing and is adjacent to and/or positioned through the surface 34 when the shackle 40 is in the first position, can have a first cross-section 78 of any shape as long the end of the second leg 42B has a second cross-section 76 of a smaller area than the first cross-section 78, 80 such that the lower portion of the enlarged transverse portion 86 of the shackle 40 forms a shield 44A, 44B for at least one end of the second and first legs 42b, 42A. Referring to FIG. 27, the first and second cross-sections 76, 78 can be generally circular. Referring to FIG. 28 the first and second cross-section 76, 78 may be concentrically aligned when the shackle is viewed along a longitudinal axis of one of the first and second legs 42A, 42B.

Referring to FIGS. 18, 22, and 23, the padlock 30:1-30:11 preferably includes a locking mechanism 70 adapted to detachably secure a portion of at least the second leg 42B within the lock housing 32 when the shackle is in the first position. Referring to FIGS. 6 and 22A, while the padlocks 30:1-30: 11 of the present invention are shown with the lock mechanism 70 being either a single ball bearing locking mechanism or a double ball bearing 52 locking mechanism, those of ordinary skill in the art will appreciate that any known locking mechanism can be used with the padlocks 30:1-30:11 of the present invention.

Referring to FIGS. 3, 10, 14, 19, 22, and 23, it is preferable that when the shackle 40 is in the first position, a portion of the shield 44A directly contacts the surface 34 of the lock housing 32 to cover any gap between the inner surface 38A of the bore 36A and the second leg 42B of the shackle 40. When the padlock 30:1-30:11 includes a second shield 44B, it is preferable that the second shield 44B be disposed on the first leg 42A of the shackle 40 and cover any gap between the first leg 42A and second inner surface 38B when the shackle 40 is in the first position.

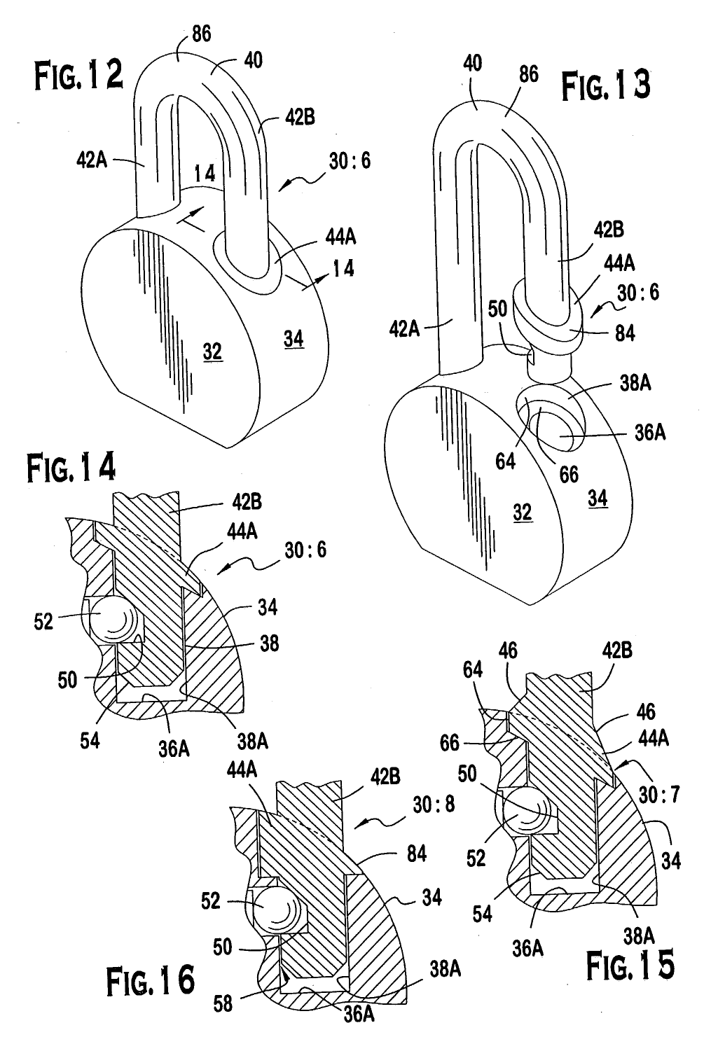

Those of ordinary skill in the art will appreciate from this disclosure that depending on manufacturing tolerances and depending on the desired design, the padlock 30:1-30:11 of the present invention may use one or more shields 44A, 44B that do not directly contact the surface 34 of the lock housing 32 while still being included in the present invention. For example, referring to FIG. 7A, when the shackle 40 is in the first position, a portion of the shield 44A is located proximate to the surface 34 of the lock housing 32 to define a rigid pathway 60 that extends generally through and approximately ninety (90) degree bend 90. The approximately ninety (90) degree bend 90 of the rigid pathway 60 is adapted to prevent a lock pick from being slid into the bore 36A between second leg 42B and the inner surface 38A of the bore 36A. In general, for a lock pick or shank to be inserted between the second 42B and the inner surface 38A of the bore 36A, the lock pick must be razor thin. As such, having to traverse the ninety (90) degree bend 90 results in the relatively rigid razor sharp lock pick or shank being ineffective. Referring to FIG. 22A, it is preferred that a second shield 44B is located proximate to the surface 34 of the lock housing 32 to define a second rigid pathway 60B that extends generally through an approximately ninety (90) degree bend 90. The approximate ninety (90) degree bend 90 of the second rigid pathway 60B is adapted to prevent a lock pick from being slid into the second bore 36B between the first leg 42A and second inner surface 38B of the second bore 36B. Referring to FIGS. 13, 15, and 22A, when the lower edge of the shields 44A, 44B are recessed within the surface 34 and positioned proximate to a shoulder 66, the rigid passageway 60 extends through two generally ninety (90) degree bends to further protect the padlock 30:1-30:11 from being disabled by a lock pick or shank.

As best shown in FIG. 7A, the rigid passageway 60 preferably includes first and second passages 88A, 88B. The first passage is at least partially bounded by the combination of the shield 44A and the surface 34 of the lock housing 32. That is, the lower surface of the shield 44A and the top surface of the lock surface 34 provide upper and lower boundaries for the first passage 88A of the rigid pathway 60. The second passage 88B is at least partially bounded by the combination of the inner surface 38A of the bore 36A and the second leg 42B. Referring to FIG. 22A, it is preferred that the first passage 88A defines a first distance 92A as measured between the surface 34 that forms the shoulder 66 and the shield 44A generally along a perpendicular to the surface 34 that forms the shoulder 66. The second passage 88B preferably defines a second distance 92B as measured between an outer surface of the second leg 42B and the inner surface 38A of the bore 36A as measured generally outwardly in a radial direction from the second leg 42B. It is preferred, but not necessary that the first distance 92A is equal to or less than the second distance. It is also preferred, but not necessary, that the first distance 92A be less than about three millimeters.

Referring to FIGS. 1-4, 6, and 7, one embodiment of the padlock 30:1 of the present invention operates as follows. When the padlock shackle 40 is depressed so that the second leg 42B is inserted within the bore 36A, a locking mechanism 70 engages the ball bearing 52 with the notch 50 in the second leg 42B to secure the shackle 40 in the first position. When the shackle is in the first position, the lower end of the shield 44A preferably directly contacts a portion of the lock housing 32 to a essentially cover at least a part of any gap 58 between an inner surface 38A of the bore 36A and the lower end of the second leg 42B. By covering the portion of the any gap 58 that extends vertically above the ball bearing 52, the shield 44A prevents the insertion of a lock pick or shank into the padlock 30:1 and thus, provides increased tamper resistance relative to other known padlocks. As the shields 44A, 44B are formed of rigid material, it is not possible to deform the shields 44A, 44B by merely pressing a lock pick or shank with greater force against a lower edge thereof as would be possible if the shank were formed of an elastomer or soft polymer. Thus, the padlocks 30:130:11 of the present invention dramatically reduce the ability of unauthorized personnel disabling the padlock 30:1-30-11 using a lock pick or shank that has been inappropriately obtained from law enforcement personnel.

While various shapes, configurations, surface shapes, shoulder angles, and shield configurations have been described above and shown in the drawings for the various embodiments of the present invention, those of ordinary skill in the art will appreciate from this disclosure that any combination of the above features, shields, bores, grooves, shoulders or the like can be used without departing from the scope of the present invention. Accordingly, it is recognized by those skilled in the art, that changes may be made to the above-described embodiments of the invention without departing from the broad invention concept thereof. It is understood, therefore, that this invention is not limited to the particular embodiments disclosed, but is intended to cover all modifications which are within the spirit and scope of the invention as defined by the appended claims and/or shown in the attached drawings.

I claim:

1. A tamper resistant padlock, comprising:
a lock housing having a surface defining a bore having an inner surface;
a shackle having first and second legs and being moveable between a first position, in which the first and second legs are located within the lock housing with the second leg being disposed in the bore, and a second position, in which the second leg is separated from the bore of the lock housing;
a shield disposed around the second leg, the shield being formed of a rigid material and being any one of welded to the second leg and integrally formed with the shackle;
a locking mechanism adapted to detachably secure a portion of the second leg within the lock housing when the shackle is in the first position; and
wherein when the shackle is in the first position, a portion of the shield directly contacts the surface of the lock housing to cover any gap between the inner surface of the bore and the second leg of the shackle.

2. The padlock of claim 1, wherein the shield has a generally annular shape.

3. The padlock of claim 1, wherein the shield has an outer perimeter defining a generally square shape.

4. The padlock of claim 1, wherein the shield comprises a generally tubular sleeve.

5. The padlock of claim 4, wherein the shield has a longitudinal length of approximately one half (½) inch.

6. The padlock of claim 4, wherein the shield has an end, facing generally away from the surface, that is beveled.

7. The padlock of claim 4, wherein the surface is curved and an end of the shield is curved to complement the surface when the shackle is in the first position.

8. The padlock of claim 1, wherein the surface defines a groove about at least a portion of the bore to define a shoulder.

9. The padlock of claim 8, wherein the groove receives at least a portion of the shield therein so that a portion of the shield is positioned adjacent the shoulder.

10. The padlock of claim 9, wherein the groove receives the shield therein such that the shield is flush with the surface.

11. The padlock of claim 1, wherein at least a portion of the shackle has a generally oval cross-section.

12. The padlock of claim 11, wherein the shackle comprises the first and second legs and a transverse portion, the transverse portion having a generally oval cross-section.

13. The padlock of claim 1, wherein the surface of the lock housing defines a second bore having a second inner surface, the first leg of the shackle being slidably disposed in the second bore, a second shield being disposed on the first leg of the shackle and covering any gap between the first leg and the second inner surface when the shackle is in the first position.

14. A tamper resistant padlock, comprising:
a lock housing having a surface defining a bore having an inner surface;
a shackle having first and second legs and being moveable between a first position, in which the first and second legs are located within the lock housing with the second leg being disposed in the bore, and a second position, in which the second leg is separated from the bore of the lock housing;
a shield disposed around the second leg, the shield being formed of a rigid material and being any one of welded to the second leg and integrally formed with the shackle;
a locking mechanism adapted to detachably secure a portion of the second leg within the lock housing when the shackle is in the first position; and
wherein when the shackle is in the first position, a portion of the shield is located proximate the surface of the lock housing to define a rigid pathway that extends generally through an approximately ninety (90) degree bend, whereby the approximately ninety (90) degree bend of the rigid pathway is adapted to prevent a lock pick from being slid into the bore between the second leg and the inner surface of the bore.

15. The padlock of claim 14, wherein the rigid passageway comprises first and second passages, the first passage being at least partially bounded by the combination of the shield and the surface of the lock housing, the second passage being at least partially bounded by the combination of the inner surface of the bore and the second leg.

16. The padlock of claim 15, wherein the first passage defines a first distance as measured between the surface and the shield generally along a perpendicular to the surface, the second passage defines a second distance as measured between an outer surface of the second leg and the inner surface of the bore as measured generally outwardly in a radial direction from the second leg, the first distance being equal to or less than the second distance.

17. The padlock of claim 15, wherein the first passage defines a first distance as measured between the surface and the shield generally along a perpendicular to the surface, the first distance being less than about three (3) millimeters.

18. The padlock of claim 14, wherein the shield has a generally annular shape.

19. The padlock of claim 14, wherein the shield has an outer perimeter defining a generally square shape.

20. The padlock of claim 14, wherein the shield comprises a generally tubular sleeve.

21. The padlock of claim 20, wherein the shield has a longitudinal length of approximately one half (½) inch.

22. The padlock of claim 20, wherein the shield has an end, facing generally away from the surface, that is beveled.

23. The padlock of claim 20, wherein the surface is curved and an end of the shield is curved to complement the surface when the shackle is in the first position.

24. The padlock of claim 14, wherein the surface of the lock housing defines a second bore having a second inner surface, the first leg of the shackle being slidably disposed in the second bore, a second shield being disposed on the first leg of the shackle, when the shackle is in the first position, a portion of the second shield is located proximate the surface of the lock housing to define a second rigid pathway that extends generally through an approximately ninety (90) degree bend, whereby the approximately ninety (90) degree bend of the second rigid pathway is adapted to prevent a lock pick from being slid into the second bore between the first leg and the second inner surface of the second bore.

25. A tamper resistant padlock, comprising:
a lock housing having a surface defining a bore having an inner surface;
a shackle having first and second legs and being moveable between a first position, in which the first and second legs are located within the lock housing with the second leg being disposed in the bore, and a second position, in which the second leg is separated from the bore of the lock housing, a portion of the second leg, that is at least partially outside the lock housing and is adjacent and/or positioned through the surface when the shackle is in the first position, has a generally oval cross-section, an end of the second leg has a generally circular cross-section of a smaller area than the generally oval cross-section such that the portion forms a shield for the end of the second leg;
a locking mechanism adapted to detachably secure a portion of the second leg within the lock housing when the shackle is in the first position; and
wherein when the shackle is in the first position, the shield extends across any gap between the inner surface of the bore and the second leg of the shackle to cover at least part of the any gap.

26. The padlock of claim 25, wherein the surface defines a groove about at least a portion of the bore to define a shoulder.

27. The padlock of claim 26, wherein the groove receives at least a portion of the shield therein so that a portion of the shield is positioned adjacent the shoulder.

28. The padlock of claim 25, wherein the surface of the lock housing defines a second bore having a second inner surface, the first leg of the shackle being slidably disposed in the second bore, a second shield being disposed on the first leg of the shackle, when the shackle is in the first position, the second shield extends across any gap between the second inner surface of the second bore and the first leg of the shackle to cover at least part of the any gap.

29. A tamper resistant padlock, comprising:
a lock housing having a surface defining a bore having an inner surface;
a shackle having first and second legs and being moveable between a first position, in which the first and second legs are located within the lock housing with the second leg being disposed in the bore, and a second position, in which the second leg is separated from the bore of the lock housing, a portion of the second leg, that is at least partially outside the lock housing and is adjacent and/or positioned through the surface when the shackle is in the first position, has a first cross-section, an end of the second leg has a second cross-section of a smaller area than the first cross-section such that the portion forms a shield for the end of the second leg;
a locking mechanism adapted to detachably secure a portion of the second leg within the lock housing when the shackle is in the first position; and
wherein when the shackle is in the first position, the shield extends across any gap between the inner surface of the bore and the second leg of the shackle to cover at least part of the any gap.

30. The padlock of claim 29, wherein the first and second cross-sections are each generally circular.

31. The padlock of claim 30, wherein the first and second cross-sections are generally concentrically aligned.
